(19) United States
(12) Patent Application Publication
(10) Pub. No.: US 2011/0162681 A1
(43) Pub. Date: Jul. 7, 2011

(54) TRANSFER CONVEYOR FITTED WITH AN AUTOMATIC CONTAINER WASHING SYSTEM

(75) Inventor: Jean-Jacques Mulleris, Neuilly Sur Seine (FR)

(73) Assignee: ATUSER SARL, Neuilly Sur Seine (FR)

(21) Appl. No.: 13/058,628

(22) PCT Filed: Jul. 31, 2009
(86) PCT No.: PCT/FR2009/000963

§ 371 Date: Mar. 28, 2011

(30) Foreign Application Priority Data
Aug. 12, 2008 (FR) 08/04576

(51) Int. Cl. B08B 9/08

(52) U.S. Cl. 134/32; 134/137

(57) ABSTRACT

A transfer conveyor comprises a mechanical structure with wheels. A container for liquids is attached to the lower portion of the mechanical structure. The upper portion of the mechanical structure enables the transfer conveyor to move. The transfer conveyor has a reversible pumping system connected to a pumping line by a flexible conduit and is sealingly connected to the container by a rigid conduit. The transfer conveyor has a system for automatically washing the container and a system for automatically managing and controlling the pumping system and the automatic washing system in order to enable liquid transport as well as the filling, draining, and automatic washing of the container.

This invention relates to the field of waste edible oil handling and offers, more particularly, a transfer conveyor fitted with an automatic container washing system.

To convey waste edible liquids from the place where they were used to the storage container, it is common to use a transfer conveyor composed of a mobile container mounted on two wheels and of a supporting element. The transfer conveyor is fitted with a filling orifice that is positioned below the discharge orifice on the cooking equipment, for example a deep fryer oil container, to receive the waste oil. Once the device has been drained or when the transfer conveyor is full, the latter is then displaced to the storage container into which the content is poured through a drain hose and a manual or motor-actuated pump.

In document FR 2 827 590, a transfer conveyor designed, in particular, for conveyance between a place or a device of use and a place for storage or drainage of oil, grease or edible liquids, for example deep fryer oil. The transfer conveyor for waste edible liquids comprises at least a mobile container fitted with at least one filling orifice and at least a drain line. The filling orifice includes tight connecting pieces designed to be used with closing elements, to avoid spillage of liquid that could be caused by vibrations during transport, including when the maximum temperature of the edible liquid is reached.

This type of all-terrain technology is to be used for transfer, from the bottom of the cooking equipment, of the waste edible liquid into the container mounted fixed on the transfer conveyor, and for pumping of the waste edible liquid from the container towards the storage device. The oil in the cooking equipment may splash the operator during drainage if the transfer conveyor has not been correctly positioned. Besides, this type of conveyor cannot be adapted to any type of cooking equipment; which causes problems when a new model of cooking equipment is installed. Moreover, the transfer conveyor is composed of metal parts that may cause burn hazards if the operators touch the walls of the transfer conveyor.

There are also some transfer conveyors fitted with at least a pumping device, including a mechanical structure with wheels, a retaining device to which is mounted at least a fixed container including at least a volume; the upper portion of said structure enabling the operator to use said transfer conveyor to convey the fixed container(s). Each pumping device is attached to the structure and connected to a pumping line including safety mechanisms and to the fixed container for transfer operations of the edible liquid. Each pumping device is reversible, one for new edible liquids and another one for waste edible liquids; the device for pumping new edible liquids being separated from the system for pumping waste edible liquids.

However, to clean this type of transfer conveyors, the user must remove the container fixed to the transfer conveyor retaining device, open the container and then clean it manually or place it into an automatic washing machine. Consequently, cleaning of the container is tedious and requires some time; more generally, the users of the transfer conveyor do not clean the waste oil container; which leads to proliferation of bacteria damaging the quality of the waste oil.

The purpose of this invention is to compensate for one or several disadvantages of the prior art and to offer a transfer conveyor equipped with an automatic container washing system enabling to avoid proliferation of bacteria inside the container.

To obtain this result, the transfer conveyor including a mechanical structure with wheels, a liquid container fixed to the mechanical structure, the mechanical structure enabling the operator to actuate said transfer conveyor; the transfer conveyor being equipped with a reversible pumping device connected to a pumping line by a first flexible conduit and sealingly connected to the container by a rigid conduit, is characterised in that the transfer conveyor is fitted with an automatic container washing system and a management and control system for the pumping system and the automatic washing system to allow filling, draining and automatic cleaning of the container.

According to another particular embodiment, the automatic washing system includes at least a module receiving the control signals from the management and control system and an auto-rotating cleaning nozzle sinking into the container through a tight orifice provided on top of the container.

According to another particular embodiment, power is supplied to the management and control system via a battery and the system includes:
a user interface
a module for receiving information originating from, on the one hand, a temperature measurement device located at the free end of the pumping line, on the other hand, a liquid filling level sensor located in the container, and at last, a system sensing the presence of the pumping line in a compartment and a battery capacity gauge:
a module for processing the information received;
a module for emitting control signals that are sent either to the washing system or to the pumping system according to the operating mode that has been chosen by the user via the user interface on the management and control system.

According to another particular embodiment, the user interface includes at least:
an ON/OFF switch enabling the user to turn on or off the management and control system;
a switch enabling the user to select either the operating mode known as “suction mode” of the pumping device, or the operating mode known as “return mode” of the pumping system, or the “stop mode” of the pumping device;
a display screen enabling display of information or error messages for the user;
a warning light informing the user of a functional failure of one of the elements on the transfer conveyor; and
a battery level indicator on the management and control system.

According to another particular embodiment, the processing module of the management and control system is capable of controlling display of information or error messages appearing on the display screen of the user interface or of switching on the light indicator in case of a functional failure or the battery level indicator.

According to another particular embodiment, the management and control system is capable of controlling, through control signals sent via the emitting module of the management and control system, a thermal safety system installed on the free end of the pumping line to prevent pumping at a temperature higher than the set temperature and a plugging system at the free end of the pumping line to avoid spillage of the residual liquid inside the pumping line on the floor once pumping is completed.

According to another specific embodiment, the management and control system includes a memory used for storing at least:
all functional parameters specific to the pumping system and the washing system,
the functional failures specific to one of the elements fitted onto the transfer conveyor.

According to another specific embodiment, said information stored in the memory of the management and control system can be retrieved by a portable maintenance system used by an authorized operator, by connecting this portable maintenance system to at least one outlet port located on the management and control system in order to detect a functional failure of the transfer conveyor, carry out the maintenance operations and determine the transfer conveyor operation conditions in order to improve the use and ergonomics of the transfer conveyor.

According to another specific embodiment, the pumping system, the washing system except for the washing nozzle, the management and control system and the battery are located in a sealed box fixed to the mechanical structure of the transfer conveyor and on top of the container.

According to another specific embodiment, a compartment is provided in the box to receive the pumping line and it is fitted with the system sensing the presence of the pumping line in its compartment and with a clamping device enabling to keep the pumping line clamped in its compartment.

According to another specific embodiment, the system sensing the presence of the pumping line in its compartment is capable of transmitting information concerning the presence of the pumping line in its compartment to the management and control system; so that, the system sensing the presence of the pumping line in its compartment sends a signal to the management and control system if the pumping line is not located in its compartment when any operation other than pumping of liquid is triggered; once the information has been analyzed and the handling error has been detected, an error message being displayed on the screen of the management and control system in order to keep the user informed.

According to another specific embodiment, the system detecting the container filling level is capable of transmitting information concerning the container filling level to the management and control system; so that, once this information has been processed, the management and control system can send an error message that is displayed on the screen of the management and control system if the container is full and to stop filling by suction and pouring more liquid into the container that is already full.

According to another specific embodiment, the system detecting the container filling level is of mechanical type, such as a gauge, and it can be replaced with any other mechanical or electronic devices used for indicating a level.

According to another specific embodiment, the mechanical structure of the transfer conveyor includes an upper portion to be used for handling the transfer conveyor; this upper portion being equipped with a removable box designed for receiving absorbent paper and a dustbin.

According to another specific embodiment, the pumping device is electrical, thermal or pneumatic.

According to another specific embodiment, the end of the second line connecting the container and the pumping system ends up near the bottom of the container so that the distance between the end of the second line located near the bottom of the container and the bottom of the container is chosen to enable suction of almost the totality of the liquid inside the container.

According to another specific embodiment, the end of the second line ends up in a boss made in the bottom of the container and forming a receptacle.

According to another specific embodiment, the pumping line is fitted, at its free end, i.e. the end in contact with the liquid to be pumped, with a thermal safety system to prevent handling of waste edible liquid at a high temperature; which may cause burn hazards to the users.

According to another specific embodiment, the free end of the pumping line in contact with the liquid to be pumped is fitted with a temperature measurement device to provide information representative of the temperature of the edible liquid to be pumped; this information being sent to the management and control system of the transfer conveyor.

According to another specific embodiment, the free end of the pumping line is fitted with a filtering system through which liquids flow, whereas solid particles with a size greater than the size that has been set are retained to avoid unwanted solid waste to be introduced into the container and originating or not from the cooking equipment.

According to another specific embodiment, the free end of the pumping line in contact with the liquid to be pumped is possibly fitted with a plugging system actuated by the management and control system as soon as pumping of liquid is completed so as to avoid spillage, on the floor, of liquid residues in the pumping line when liquid transfer operations are completed.

According to another specific embodiment, the pumping line is equipped with a handle covered with adhesive and heatproof material to enable the user to easily grab the pumping line without burning himself.

According to another specific embodiment, the invention allows conveyance of waste edible liquids, draining or filling of the container (2) via the pumping device (12), cleaning and automatic rinsing of the container via an automatic washing system.

According to another specific embodiment, the cleaning step requires pumping with the use of the pumping line (120) of a water volume not exceeding the volume of the container (2) to which a given quantity of detergent has been added, and discharge of the same volume once the cleaning cycle is over.

According to another specific embodiment, the rinsing step requires pumping with the use of the pumping line (120) of a water volume not exceeding the volume of the container (2) the discharge of the same volume once the cleaning cycle is over.

The invention, with its purposes, characteristics, details and advantages, will emerge more clearly from the following description given in reference to the attached diagrams in which:

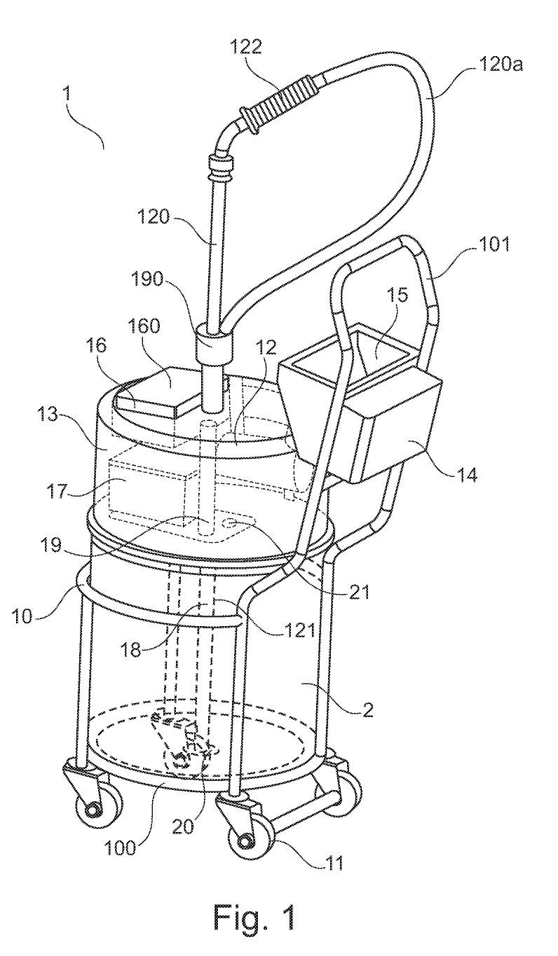

FIG. 1 illustrates the transfer conveyor fitted with an automatic container washing system;

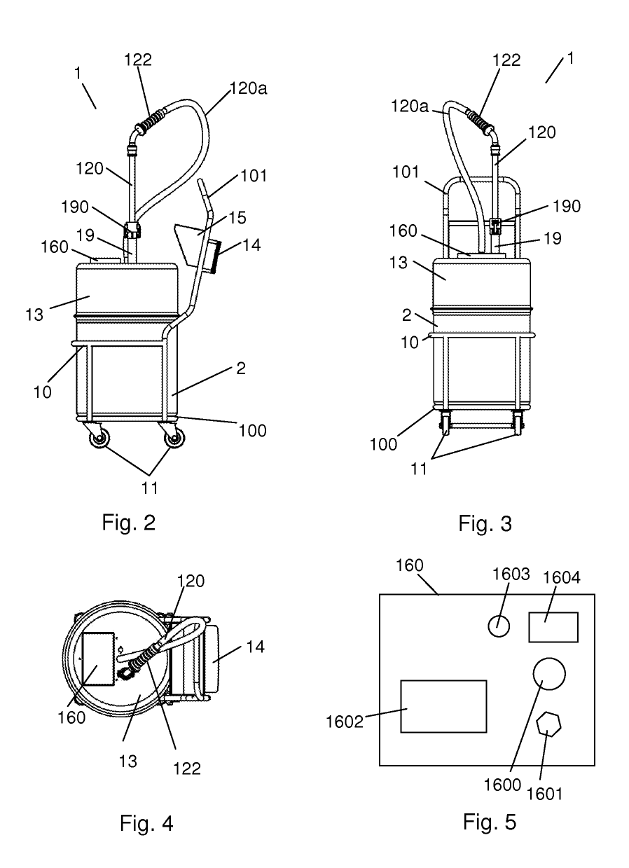

FIG. 2 shows a side view of the transfer conveyor according to the invention;

FIG. 3 shows a front view of the transfer conveyor according to the invention;

FIG. 4 shows a top view of the transfer conveyor according to the invention;

FIG. 5 illustrates the user interface of the conveyor management and control system according to the invention; and

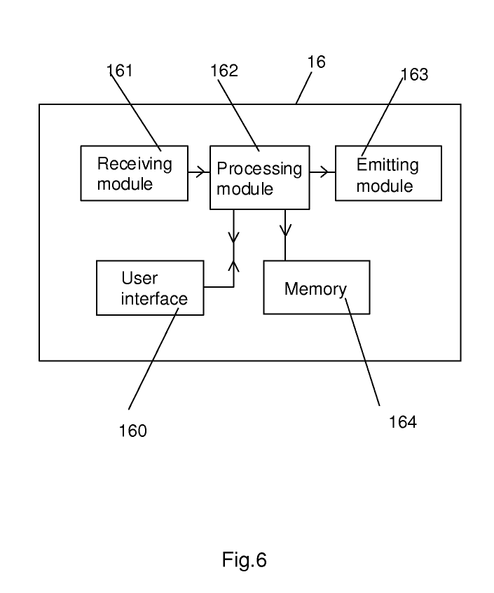

FIG. 6 illustrates the management and control system of the conveyor pumping system.

The description of the invention is following in reference to the diagrams that have been cited above.

The invention concerns a transfer conveyor (1) fitted with an automatic washing system enabling to avoid proliferation of bacteria inside the container (2) of the transfer conveyor (1). The invention is more particularly designed for restaurants equipped with a recovery or storage container whereof size is greater than the size of the container (2) of the transfer conveyor (1) and enables, in an easy and secure way, draining, by the user, of waste edible oil from the cooking equipment towards the recovery container whereof size is greater.

The transfer conveyor (1) is composed of a mechanical tubular structure (10) mounted securely on a system of wheels (11). The mechanical structure (10) has the shape of a trolley and is composed of:
a lower portion (100) under which is fixed the system of wheels (11) and on top of which is fixed at least one container (2); and
an upper portion (101) enabling the operator to handle said transfer conveyor (1).

For convenience purposes, the upper portion (101) has the shape of a cradle at man's height and is interdependent with the mechanical structure (10) to allow the operator to move the transfer conveyor (1) without to have to bend down.

To be able to ensure permanent stability and to immobilize the transfer conveyor (1) safely, for example and without limitation, when transferring edible liquid or washing the container (2), the system of wheels (11) is composed of 2, 3 or 4 omnidirectional or unidirectional wheels that can be fitted with a common braking system. In the example shown, the transfer conveyor (1) is fitted with 4 wheels (11).

For convenience purposes, the size of the transfer conveyor (1) has been minimized so as to be able to handle it easily in narrow places or in service lifts.

The transfer conveyor (1) is designed for being used with a container (2) fixed to the structure (10) of the transfer conveyor (1) with tightening screws so as to have the container (2) positioned on top of the lower portion (100) of the mechanical structure (10) of the transfer conveyor (1).

The container (2) is made of rigid material, for example and without restriction, plastic or metal, to contain a given volume of edible liquid either new liquid or waste liquid or a mixture of water and detergent used when cleaning the container (2). In the example shown, the container (2) has a cylindrical shape. Without restriction, all other shapes of container (2) may be considered.

Moreover, the transfer conveyor (1) is fitted with a reversible pumping system (12), i.e. either capable of being alternatively actuated for pumping or injecting liquid. The pumping system (12) is arranged in a box (13) fixed on top of the container (2).

The pumping system (12) includes a pumping circuit, for example and without restriction, a motor with at least one pumping unit. Without restriction, the pumping system (12) is of electrical, thermal or pneumatic type. The pumping system (2) of electrical type is, without restriction, a vane pump, a diaphragm pump, a flexible impeller pump or a peristaltic pump.

The pumping system (12) is sealingly connected to a pumping line (120) by a first flexible conduit (120a) and sealingly connected to the container (2) positioned on the transfer conveyor (1) by a second rigid conduit (121) ending up near the bottom of the container (2).

The distance between the end of the second line (121) located near the bottom of the container (2) and the bottom of the container (2) is chosen to enable suction of almost the total quantity of liquid inside the container (2).

The end of the second line (121) ends up in a boss (20) made in the bottom of the container (2) forming a receptacle. The end of the second line (121) is then positioned below the bottom of the container (2). Consequently, when the container (2) is emptied by suction, the total quantity of liquid, except for a small quantity corresponding roughly to the volume of the boss from which the second line sinking depth in the boss is retrieved, is sucked up. This characteristic therefore allows to keep an insignificant quantity of liquid in the container (2),In an example of embodiment, the boss has, for example, a cylindrical shape with a diameter greater than the diameter of the second line (121).

The pumping line (120) working with the pumping system (12) is designed for suction of either edible liquid, such as waste edible oil from a cooking equipment in the container (2) or a mixture of water and detergent from a receptacle, such as a restaurant wash tank, to inject it into the container (2) and for suction of the edible liquid or water/detergent mixture in the container (2) to inject it respectively into a larger recovery container or into a grease container in order to be disposed of.

The pumping line (120) is fitted, at its free end, i.e. the end in contact with the liquid to be pumped, with a thermal safety system (not shown).

The thermal safety system is, for example, of electrical type (with bimetallic elements) to prevent discharge of waste edible liquid from the cooking equipment towards the container (2) if the waste edible liquid has reached a temperature that is higher than the set temperature threshold. The thermal safety system of electrical type is, for example and without restriction, a bimetallic element of a pump switch control. The thermal safety system is triggered via a control signal emitted by the management and control system (16) of the transfer conveyor (1) and it depends on the information provided by the temperature measurement device (not shown) that is also located at the free end of the pumping line (120). If the temperature is indeed higher than the set temperature threshold, the thermal safety system is actuated and the user cannot pump the liquid.

For convenience purposes, this thermal safety system prevents handling of the waste edible liquid at a high temperature; which may cause burn hazards to the users.

Once the thermal safety system has been actuated, the thermal safety system is reactivated either automatically or manually by changing or not the active safety elements to allow new liquid transfer operations using the same pumping line (120).

As described previously, the free end of the pumping line (120) in contact with the liquid to be pumped is fitted with a temperature measurement device to provide information representative of the temperature of the edible liquid to be pumped; the information being then sent to the management and control system (16) of the conveyor (1). This temperature measurement device is common to all systems used for measuring temperatures with direct contact or not, for example and without restriction, a temperature probe or a remote infrared measurement equipment.

To avoid unwanted solid waste originating from the cooking equipment or not, to be introduced into the container (2), the free end of the pumping line (120) is fitted with a filtering system (not shown) through which liquids flow whereas solid particles whereof size is greater than the given size are retained. The system is indeed adjusted according to the grain size of the solid waste accepted in the liquid to be pumped.

To avoid spillage of liquid residues in the pumping line (120) on the floor when liquid transfer operations are completed, the free end of the pumping line (120) in contact with the liquid to be pumped is possibly fitted with a plugging system (not shown) actuated by a management and control system (16) as soon as pumping of the liquid is completed.

The pumping line (120) is also fitted with a handle (122) covered with adhesive and heatproof material to enable the user to easily grab the pumping line (120) without burning himself.

The upper portion (101) of the mechanical structure (10) of the transfer conveyor (1) used by the user to handle the transfer conveyor (1) is fitted with a box that can be removed or not (14) in which absorbent paper can be found and with a dustbin (15); so that, the user has within reach everything he may need in case of, for example, leaks from the pumping line (120), spillage of edible oil, etc. The box (14) containing absorbent paper and the dustbin (15) are fixed to the cradle forming the upper portion (101) of the mechanical structure (10) of the transfer conveyor (1).

The box (13) arranged on top of the container (2) and receiving the pumping system (12) is also designed to receive the management and control system (16) of the transfer conveyor (1) and a compartment (19) used for supporting the pumping line (120) of the pumping system (2).

Power supply of the management and control system (16) is performed by a rechargeable battery (17) also arranged inside the removable sealed box (13) that is fixed on top of the container (2).

To charge the battery (17), for example a 12 V lead battery (12 amps), a plug is provided on the box (13) of the transfer conveyor (1) to connect a charger to the power battery (17) of the management and control system (16).

The management and control system (16) includes an interface user (160) that is connected to a module (162) for processing the information from the management and control system (16).

It must be noticed that the term “module”, used in the rest of the description, defines all electronic circuits associated to an application software or a program enabling given functionalities to be performed for each module.

In reference to FIG. 5, the user interface (160) includes at least the following elements:
an OFF/ON switch or selector (1600) enabling the user to respectively turn ON or OFF the management and control system (16);
a switch or selector (1601) enabling the user to select either the operating mode known as “suction” of the pumping system (12), or the operating mode, known as “return” of the pumping system (12) or the operating mode, known as “stop”, of the pumping device (12);
a display screen (1602), for example an LCD screen, enabling display, for the user, of the message errors, such as “Danger! Boiling hot oil”, or information messages such as messages indicating the operating mode of the pumping device (12), “stop”, “suction”, “return” or even “cleaning” and messages indicating the temperature of the liquid to be pumped or the container (2) washing cycle countdown, etc.
light indicator (1603) informing the user of a functional failure of one of the elements on the transfer conveyor (1); and
power battery (17) level indicator (1604) of the management and control system (16)

It must be noticed that the elements of the user interface (160) previously described are positioned on top of the box (13).

The receiving module (161) of the management and control system (16) of the pumping system (12) is designed for receiving the information from the temperature measurement device fitted at the free end of the pumping line (120), a system sensing the filling level (21) of the liquid inside the container (2), a system sensing the presence (not shown) of the pumping line in the compartment (19) of the box (13) and a battery capacity gauge (17).

These data are processed by the processing module (162) of the management and control system (16) shown on FIG. 6. Depending on the operating mode chosen by the user via the user interface (160), the management and control system (16) is capable of controlling the pumping system (12) or the washing system by sending control signals from the emitting module (163) of the management and control system (16) to either the pumping system (12) or to the container washing system (2).

Moreover, the processing module (162) of the management and control system (16) is capable of controlling the display of an error or information message on the display screen (1602) of the user interface (160) or switching on the light indicator (1603) showing a functional failure or the battery level indicator (1604).

At last, the management and control system (16) is capable of controlling, by sending control signals via the emitting module (163) of the management and control system (16), the thermal safety system to prevent pumping to occur at a temperature higher than the set temperature threshold and the pumping line plugging system to avoid that the liquid remaining in the pumping line (120) is spilled on the floor once pumping is completed.

Besides, the management and control system (16) includes a memory (164) to be used for storage of at least:
all functional parameters concerning operating of the pumping and washing systems (12),
the functional failures of one of the elements fitted on the transfer conveyor, for example, disconnection of the thermal safety system arranged at the free end of the pumping line (120).

The data stored in the memory (164) can be retrieved by a portable maintenance system used by an authorized operator. This portable maintenance system is connected by an authorized operator to at least one outlet port located on the management and control system (16) to retrieve the information stored in the memory (164). For convenience purposes, the authorized operator can detect a functional failure of the transfer conveyor (1) and then carry out the necessary maintenance operations and determine the transfer conveyor (1) operating conditions in order to improve the use and ergonomics of the transfer conveyor (1).

The compartment (19) for the pumping line (120) has the shape of a cylindrical tube inserted into a bore provided in the box (13) arranged on top of the container (2). This tube or compartment (19) used for retaining the pumping line (120) is positioned roughly perpendicularly to the top surface of the box (13) and has a diameter roughly greater than the diameter of the pumping line (120).

The tube or compartment (19) used for retaining the pumping line (120) is fitted with a system (not shown) sensing the presence of the pumping line (120) in its compartment (19) and a clamping device (190) allowing to keep the pumping line (120) clamped in its compartment (19).

Without restriction, any other retaining system for a pumping line (120) may be considered.

The system used for sensing the presence of the pumping line (120) in its compartment (19) is capable of transmitting the information on the presence of the pumping line (120) in its compartment (19) to the management and control system (16). It must be noticed that the pumping line (120) must be in its compartment (19) during each operation except during a liquid pumping operation. When the pumping line (120) is not positioned in its compartment (19) during an operation other than liquid pumping, the system for sensing the presence of the pumping line (120) in its compartment (19) sends a signal to the management and control system (16); after analysis and detection of this handling error, the system displays a message, for example, “Warning! Pumping line not in the compartment” on the screen (1602) of the management and control system (16) to keep the user informed. The user can thus position the pumping line (120) in its compartment (19) in order to proceed with these operations.

The system used for sensing the filling level (21) of the container (2) is capable of transmitting information concerning the filling level of the container (2) to the management and control system (16). Once the information is processed, the management and control system (16) can send an error message, such as “Warning! Container full”, and stop filling by suction and pouring of more liquid into the full container (2). The message error displayed on the screen (1602) of the management and control system (16) enables to inform the user on the container (2) filling status and consequently, to plan, if necessary, transfer of the liquid in the container (2) to a storage container with greater capacity. Without restriction, the system for sensing the filling level (21) is of mechanical type, such as a gauge and it can be replaced with any other mechanical or electronic device indicating a level.

The system used for sensing the liquid filling level (21) in the container (2) is, for example, positioned on top of the container (2).

The washing system includes a module receiving the control signals from the management and control system (16) and a module for controlling the auto-rotating washing nozzle (18) sinking into the container (2). The washing system operates, for example with a pressure of 2 to 5 bars and at a maximum liquid temperature of 100° C. The washing nozzle (18) sinks into the container (2) through a tight orifice provided on the container (2).

It must also be noticed that the use of a water and detergent mixture is necessary for cleaning. The detergent used can be, for example, a very small quantity of caustic soda to avoid scale and prevent proliferation of bacteria inside the container (2).

A description of a type of use of the transfer conveyor (1) according to the invention is following.

The purpose of the transfer conveyor (1) as described in the invention is to convey the fixed container (2) between the place where the edible liquid is used and the place where the waste edible liquid is stored.

The transfer conveyor (1) is also used to discharge, with the help of the pumping system (12), waste edible liquid from a cooking equipment into the fixed container (2) of the transfer conveyor (1) and to fill through the pumping system (12), a storage container used for the waste edible liquid from the fixed container (2) of the transfer conveyor (1).

For filling the container (2) with waste edible oil, the user must unclamp the pumping line (120), select the operating mode of his choice, in this example, “suction” operating mode on the switch (1601) of the user interface (160), sink the free end of the pumping line (120) into the cooking equipment container in which there is the edible oil to be pumped, then press ON on the ON/OFF switch of the user interface (160) of the management and control system (16).

When selecting ON and pressing the ON/OFF switch (1600), the management and control system (16) is switched on and the temperature of the edible liquid to be pumped is measured by the temperature measurement device arranged at the free end of the pumping line (120). The temperature measurement device sends the necessary information to the management and control system (16) that then analyzes it. Depending on the temperature of the edible liquid to be pumped, the management and control system (16) sends either a command to the pumping system for stopping pumping (12) or a command to the pumping system (12) for authorization of pumping.

In an example of embodiment, as regards pumping of waste edible oil, if the temperature of the edible oil to be pumped is lower than 20° C., the pumping system (12) receives a stop command in order to avoid damaging the pumping system (12) by pumping solidified oil; if the temperature is higher than 45° C., the pumping system (12) receives a stop command to avoid burn hazards that could be caused to the staff; pumping is authorized if the temperature is included between 20° C. and 45° C.

It must be noticed that the management and control system (16) can at the same time send a command for display of a message on the screen (1602), such as “Warning, boiling hot oil” if pumping is forbidden or “Pumping in progress” if pumping is allowed.

Once suction of oil is completed, the user can empty the flexible hose if the free end of the pumping line (120) is not fitted with a plugging system. To do so, the user must tilt the pumping line (120) upwards and press the ON/OFF switch (1600) of the user interface (160) for a few seconds.

If the free end of the pumping line (120) is fitted with a plugging system, the management and control system (16) sends a control signal to the plugging system for plugging the pumping line (120) to avoid spillage of the edible oil on the floor.

When filling of the container (2) is completed, the user must place again the pumping line (120) in its compartment (19) and clamp the pumping line (120) in its compartment (19), then reselect the “stop” mode via the selector or ON/OFF switch (1600).

For discharging the waste edible oil in the container (2) into a storage container with greater capacity, the user must unclamp the pumping line (120), select the operating mode of his choice, in this example, the “return” mode via the switch (1601) of the user interface (160), position the free end of the pumping line (120) in the filling orifice on the storage container or any other filling device existing on a storage container, then select the ON position by keeping the ON/OFF switch pressed on the user interface (160) of the management and control system (16).

When pressing the ON/OFF switch (1600), the management and control system (16) is turned on and consequently, it sends an authorization command, to the pumping system (12) for starting pumping.

It must be noticed that the management and control system (16) can at the same time control the display of a message, such as “Pumping in progress” on the screen (1602).

Once suction of oil is completed, the user can empty the hose if the free end of the pumping line (120) is not fitted with a plugging system. To do so, the user must tilt the pumping line (120) upwards and press the ON/OFF switch (1600) in ON position of the user interface (160) for a few seconds.

If the free end of the pumping line (120) is fitted with a plugging system, the management and control system (16) sends a control signal to the plugging system for plugging the pumping line (120) to avoid spillage of the edible oil on the floor.

When filling of the container (2) is completed, the user must place again the pumping line (120) in its compartment (19) and clamp the pumping line (120) in its compartment (19), then reselect the “stop” mode via the selector or ON/OFF switch (1600).

It must be noticed that the container (2) filling operation can be stopped by the management and control system (16) when the system detects that the container (2) is full, through the analysis of the signal emitted by the filling level sensing system.

Filling, draining and cleaning operations can also be stopped by the management and control system (16) when the system detects that the battery (17) of the management and control system (16) is empty through the analysis of the signal emitted by the battery capacity gauge.

Finally, to clean the container (2), the user must unclamp the pumping line (120), select the “suction” operating mode on the switch (1601) on the user interface (160), dilute the content of a pack containing a cleaning agent into a receptacle in which there is a certain quantity of hot water whereof temperature is lower than 45° C., position the end of the pumping line (120) in the receptacle containing the water/detergent mixture, then keep the ON/OFF switch of the user interface (160) of the management and control system (16) in ON position for suction of the water/detergent mixture contained in the receptacle and fill the container (2) with this mixture.

Once the container (2) is filled with this water/detergent mixture, the user must position the pumping line (120) in its compartment (19), then clamp the pumping line through the clamping device (190), position the selector (1600) on “ON” position to have a control signal sent by the management and control system (16) to the washing system that triggers a cleaning cycle and a control signal for display of a message such as “Cleaning in progress”; message that is displayed on the screen (1602) of the user interface (160).

In an example of embodiment, a washing cycle lasts approximately 2 minutes and 30 seconds.
It must be noticed that it is possible to stop the system while a cleaning cycle is in progress by positioning the selector (1600) on “STOP”.

When the cleaning cycle is completed, the user must unclamp the pumping line (120) and place the end of the pumping line (120) in a disposal device connected to the grease container, then position the selector (1600) on “ON” for draining the container (2) in which there is the water/detergent mixture used for cleaning.

It must be noticed that if the temperature of the water/detergent mixture is higher than 45° C., the pumping system (12) receives a stop command in order to avoid any burn hazards that could be caused to the staff.

For convenience purposes, once cleaning has been performed, a step for rinsing the container (2) is provided in order to avoid polluting the waste edible liquid with detergent.

This rinsing step consists in positioning the selector (1601) on “Suction”, refilling the receptacle used for dilution of the detergent/water mixture in a given quantity of hot water whereof temperature does not exceed 45° C. to avoid blocking of the pump, selecting the “ON” position via the selector (1600) for suction of the hot water contained in the receptacle in order to inject it into the container (2).

Once the container (2) is filled with hot water, the user must position the pumping line (120) in its compartment, clamp the pumping line using the clamping system (190) and start a new cleaning cycle as described above.

When the cleaning cycle is completed, the user must unclamp the pumping line (120) and place the end of the pumping line (120) in the disposal device connected to the grease container, then select “ON” via the selector (1600) in order to empty the container (2) in which there is the hot water that has been used for rinsing.

One of the advantages of the invention is that the transfer conveyor (1) as described in the invention enables automatic cleaning of the container (2) and thus avoids proliferation of bacteria in the container (2).

It must be evident for a person skilled in the art that the present invention allows embodiments in numerous other specific forms without departing from the field of application of the invention as claimed. Consequently, the present embodiments must be considered by way of illustration but can be modified in the field defined by the scope of the attached claims and the invention must not be limited to the above-mentioned details.

1. Transfer conveyor including a mechanical structure with wheels, a receptacle containing liquid and fixed to a lower portion of the mechanical structure, an upper portion of the mechanical structure enabling the operator to handle said transfer conveyor, the transfer conveyor being fitted with a reversible pumping system connected to a pumping line by a flexible conduit and sealingly connected to the receptacle by a rigid conduit, wherein the transfer conveyor is equipped with an automatic washing system and a management and control system for the pumping system and the automatic washing system to enable liquid conveyance, filling, draining and automatic cleaning of the receptacle.

2. Transfer conveyor according to claim 1, wherein the automatic washing system includes at least a module for receiving control signals emitted by the management and control system and an auto-rotating washing nozzle sinking into the container receptacle through a tight orifice provided on top of the receptacle.

3. Transfer conveyor according to claim 1, wherein the management and control system is configured to receive power from a battery and the transfer conveyor further includes:
a user interface;
a module configured to receive data emitted by a temperature measurement device located at a free end of the pumping line, a liquid filling level sensing system in the receptacle, a system sensing the presence of the pumping line in its compartment and a battery capacity gauge;
a module for processing the information received;
a module for emitting control signals sent to either the washing system or the pumping system responsive to a user selected operating mode from the user interface of the management and control system.

4. Transfer conveyor according to claim 3, wherein the user interface includes at least:
an ON/OFF switch enabling the user to respectively turn on or off the management and control system;
a switch enabling the user to select either the operating mode, known as “Suction”, of the pumping system, or the operating mode, known as “Return”, of the pumping system, or the “Stop” mode of the pumping system;
a display screen enabling display of error or information messages to be read by the user;
a light indicator informing the user of a functional failure of one of the elements on the transfer conveyor; and
a level indicator for the battery supplying the management and control system.

5. Transfer conveyor according to claim 3, wherein the processing module of the management and control system is configured to control display of an error or information message on the display screen of the user interface or to turn on the light indicator in case of a functional failure or the battery level indicator.

6. Transfer conveyor according to claim 3, wherein the management and control system is configured to control, by sending control signals via the emitting module of the management and control system, a thermal safety system fitted at the free end of the pumping line to prevent pumping if the temperature is higher than the set temperature threshold and a plugging system at the free end of the pumping line to avoid residual liquid in the pumping line to be spilled on the floor once pumping is completed.

7. Transfer conveyor according to claim 3, wherein the management and control system includes a memory used for storing information comprising at least:
one or more functional parameters of the pumping and washing systems, or
one or more functional failures of one of the elements of the transfer conveyor.

8. Transfer conveyor according to claim 7, wherein said information stored in the memory of the management and control system retrievable by a portable maintenance device the portable maintenance device being connected to at least one outlet port of the management and control system and configured to detect a functional failure of the transfer conveyor, carry out the necessary maintenance operations, determine the transfer conveyor operation conditions in order to improve the use and ergonomics of the transfer conveyor.

9. Transfer conveyor according to claim 1, wherein the pumping system, the washing system not including the washing nozzle, the management and control system and the battery are located in a sealed box fixed to the mechanical structure of the transfer conveyor and on top of the container.

10. Transfer conveyor according to claim 1, wherein a compartment is provided in the box to receive the pumping line and is fitted with the system sensing the presence of the pumping line in its compartment and with a clamping system configured to keep the pumping line clamped inside its compartment.

11. Transfer conveyor according to claim 10, wherein the system sensing the presence of the pumping line in its compartment is configured to transmit the information concerning the presence of the pumping line in its compartment to the management and control system so that, when the pumping line is not located in its compartment during an operation other than liquid pumping, the system sensing the presence of the pumping line in its compartment sends a signal to the management and control system that, after analyzing and detecting this handling error, actuates display of a message on the screen of the management and control system in order to keep the user informed.

12. Transfer conveyor according to claim 11, wherein the system sensing the filling level of the receptacle is capable of transmitting the information concerning the filling level of the receptacle to the management and control system so that, once the information has been processed and if the receptacle is full, the management and control system emits an error message that is displayed on the screen of the management and control system and stop filling when more liquid is sucked and poured into the full receptacle.

13. Transfer conveyor according to claim 12, wherein the system sensing the filling level is of mechanical type such as a gauge and is replaceable with any other mechanical or electronic device used for indicating a level.

14. Transfer conveyor according to claim 1, wherein the upper portion of the mechanical structure of the transfer conveyor used by the user for handling the transfer conveyor is fitted with a removable box designed for receiving absorbent paper and with a dustbin.

15. Transfer conveyor according to claim 1, wherein the pumping system is of electrical, thermal or pneumatic type.

16. Transfer conveyor according to claim 1, wherein the end of the second line connecting the container and the pumping system ends up near the bottom of the container, so that the distance between the end of the second line near the bottom of the container and the bottom of the container is chosen to allow suction of almost the total quantity of liquid in the container.

17. Transfer conveyor according to claim 16, wherein the end of the second line ends up into a boss made in the bottom of the container and forming a receptacle.

18. Transfer conveyor according to claim 1, wherein the pumping line is fitted with, at its free end, the thermal safety system to prevent handling of waste edible liquid at a high temperature that may cause burn hazards to the users.

19. Transfer conveyor according to claim 1, wherein the free end of the pumping line in contact with the liquid to be pumped is fitted with the temperature measurement device to provide information representative of the temperature of the edible liquid to be pumped; this information being sent to the management and control system of the transfer conveyor.

20. Transfer conveyor according to claim 1, wherein the free end of the pumping line is fitted with a filtering system through which liquids flow and solid particles having a size is greater than a given size are retained to avoid introduction of unwanted solid waste into the container, originating or not from the cooking equipment.

21. Transfer conveyor according to claim 1, wherein the free end of the pumping line in contact with the liquid to be pumped is equipped with a plugging system actuated by the management and control system as soon as pumping of liquid is completed to avoid spillage of liquid residues in the pumping line on the floor when liquid transfer operations are completed.

22. Transfer conveyor according to claim 1, wherein the pumping line is equipped with a handle covered with adhesive and heatproof material to enable the user to easily grab the pumping line without burning himself.

23. A method of using the transfer conveyor according to claim 1, conveying waste edible liquid by draining or filling of the container via the pumping system; automatic cleaning of the container through the automatic washing system; and rinsing of the container through the automatic washing system.

24. The method of use of the transfer conveyor according to claim 23, wherein the cleaning step comprises pumping, through the pumping line, a water volume not exceeding the volume of the container to which a given quantity of detergent is added and discharging of the water volume once the cleaning cycle is completed.

25. The method of use of the transfer conveyor according to claim 23, wherein the rinsing step comprises pumping, through a pumping line, a water volume not exceeding the volume of the container the discharge of the water volume once the cleaning cycle is completed.
